(19) United States
(12) Patent Application Publication
(10) Pub. No.: US 2006/0038088 A1
(43) Pub. Date: Feb. 23, 2006

(54) Aircraft wing

(76) Inventor: Robert T. Dodson, Copley, OH (US)

Correspondence Address: DON W. BULSON (GOODRICH);RENNER, OTTO, BOISSELLE & SKLAR, LLP, 1621 EUCLID AVENUE, 19TH FLOOR, CLEVELAND, OH, 44115, US

(21) Appl. No.: 11/198,641

(22) Filed: Aug. 5, 2005

Related U.S. Application Data
(60) Provisional application No. 60/603,596, filed on Aug. 23, 2004.

(51) Int. Cl. B64C 3/50

(52) U.S. Cl. 244/214

(57) ABSTRACT

An aircraft wing (12) comprising a fixed wing (14), a slat (16) movable relative to the fixed wing (14) between a retracted position and an extended position, electrical lines (36, 38) extending between the fixed wing (14) and an electrical system (34) on the slat (16), and a linkage (40). The linkage (40) houses the electrical lines (36, 38) and is convertible between a retracted condition when the slat (16) is in the retracted position and an extended condition when the slat (16) is in the extended position.

### RELATED APPLICATION

This application claims priority under 35 U.S.C. §119(e) to U.S. Provisional Patent Application No. 60/603,596 filed on Aug. 23, 2004 and entitled “Translating Wire Bundle.” The entire disclosure of this earlier provisional application is hereby incorporated by reference.

### FIELD OF THE INVENTION

This invention relates generally, as indicated, to an aircraft wing and, more particularly, to an aircraft wing having a fixed wing and a leading edge slat selectively movable relative to the fixed wing between a retracted position and an extended position.

### BACKGROUND OF THE INVENTION

An aircraft wing can include a fixed wing and a leading edge slat selectively movable relative to the fixed wing between a retracted position and an extended position. In the retracted position, the slat is situated to nest against the leading edge of the fixed wing. In the extended position, the slat is deployed by a suitable drive mechanism to extend beyond the fixed wing to increase the aerodynamic lift of the wing and/or the allowable (e.g., non-stalling) angle of attack. Typically, the leading edge slat will be retracted during high altitude flight and extended for take-offs and landings. If a slat is susceptible to ice buildup, an ice protection system will be provided for use during flight. In the past, hot gas has been used for anti-icing and deicing purposes, with extendable/retractable gas-carrying tubes extending between the fixed wing and the leading edge slat.

### SUMMARY OF THE INVENTION

The present invention provides a linkage which allows an electrical ice protection system to be used on a leading edge slat.

More particularly, the present invention provides an aircraft wing comprising a fixed wing, a slat movable relative to the fixed wing between a retracted position and an extended position, electrical lines extending between the fixed wing and an electrical system (e.g., an electrical ice protection system) on the slat; and a linkage. The linkage houses the electrical lines and is convertible between a retracted condition when the slat is in the retracted position and an extended condition when the slat is in the extended position. The linkage can comprise chambers each having a plurality of channels so that one set of electrical lines (e.g., electrical power lines) can extend through one set of channels and another set of the electrical lines (e.g. electrical sensor lines) can extend through another set of channels.

The linkage can comprise a plurality of links connected by joints to the fixed wing, the slat, and each other. For example, the plurality of links can include a first link connected to the fixed wing, a second link connected to the slat, and a third intermediate link therebetween. The first link can be connected to the fixed wing by a rotational joint (whereby the link is rotatable about its axis) and/or the second link can be connected to the slat by a gimbal joint (whereby the link is pivotal about two perpendicular axes).

These and other features of the invention are fully described and particularly pointed out in the claims. The following description and annexed drawings set forth in detail a certain illustrative embodiment of the invention, this embodiment being indicative of but one of the various ways in which the principles of the invention may be employed.

### DRAWINGS

FIGS. 1A and 1B are perspective views of an aircraft having wings according to the present invention, the wings each having a fixed wing, a leading edge slat and a linkage for housing electrical lines extending between the fixed wing and an electrical ice protection system on the slat.

FIGS. 2A and 2B are close-up partially in section views of one aircraft wing.

FIG. 3 is a top close-up view of a portion of the fixed wing showing the connection of the linkage thereto.

FIG. 4 is a front close-up view of this same portion of the fixed wing.

FIG. 5 is a side close-up view a portion of the leading edge slat showing the connection of the linkage thereto.

FIGS. 6A and 6B are close-up front views of the linkage.

FIG. 7 is a perspective view of the linkage.

### DETAILED DESCRIPTION

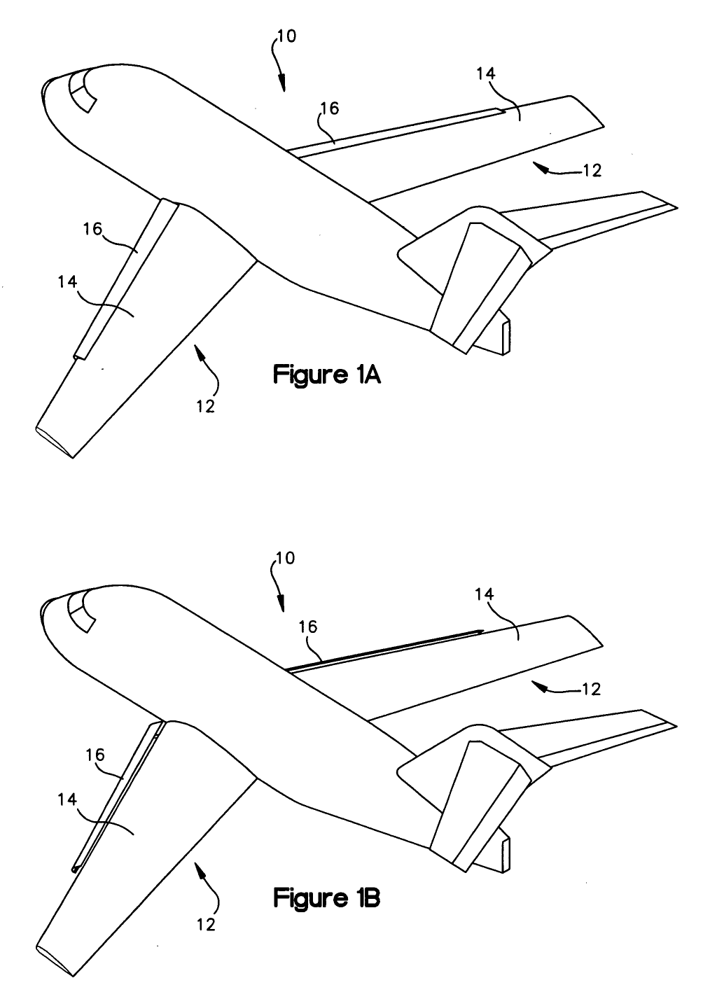

Referring now to the drawings, and initially to FIGS. 1A and 1B, an aircraft 10 having wings 12 according to the present invention is shown. The wings 12 each have a fixed wing 14 and a leading edge slat 16 selectively movable relative to the fixed wing 14 between a retracted position (FIG. 1A) and an extended position (FIG. 1B). In the retracted position, the slat 16 is situated to nest against the leading edge of the fixed wing 14. In the extended position, the slat 16 is deployed by a suitable drive mechanism (not shown) to extend beyond the fixed wing 14 to increase the aerodynamic lift of the wing 12 and/or its allowable (e.g., non-stalling) angle of attack. Typically, the leading edge slat 16 will be retracted during high altitude flight and extended for take-offs and landings.

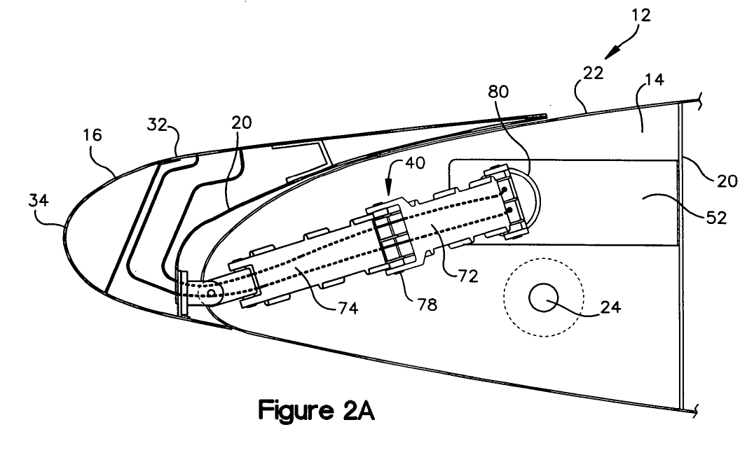

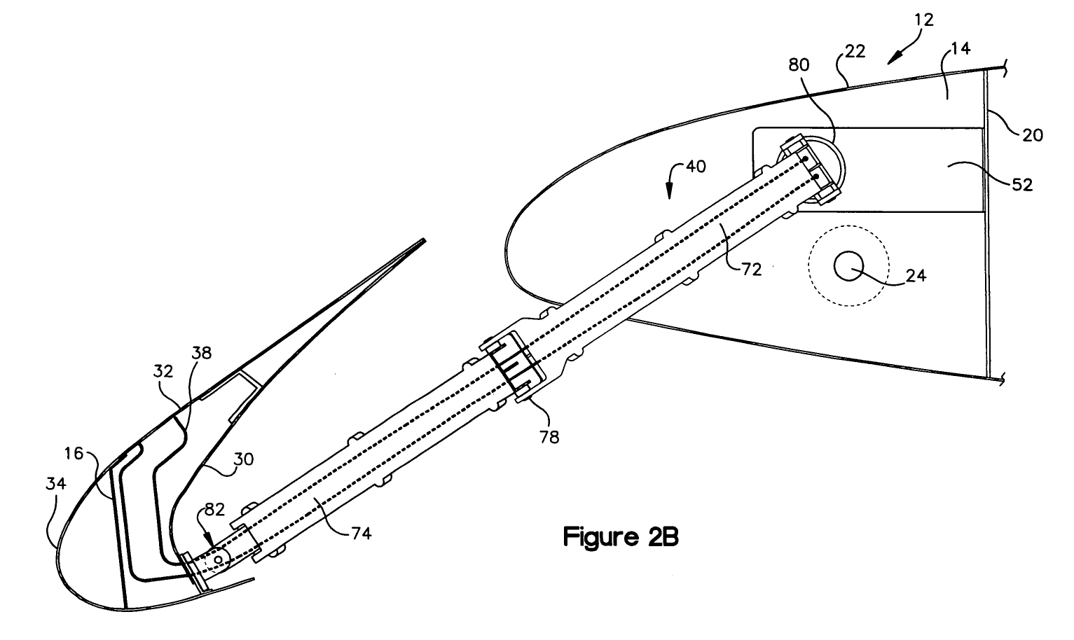

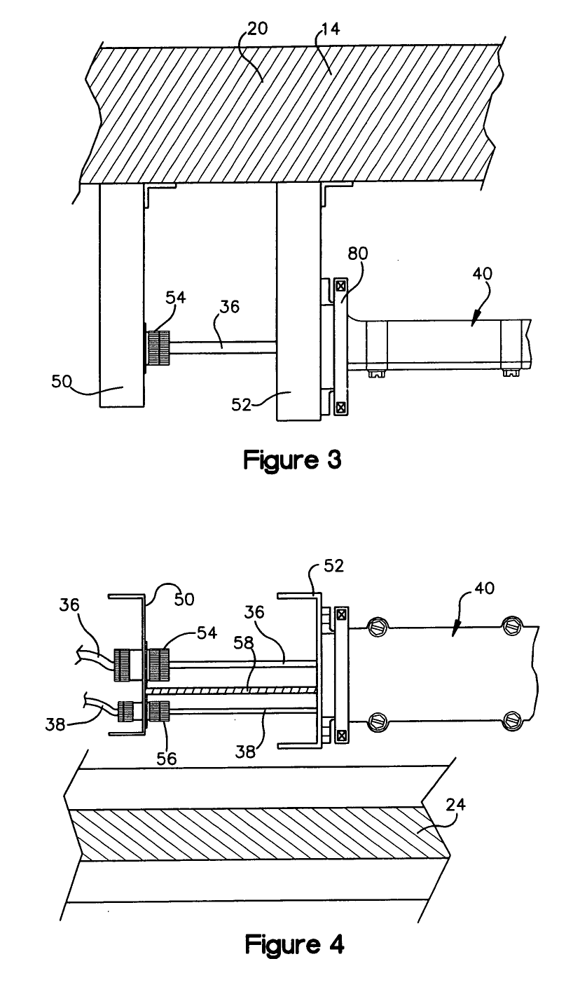

Referring now to FIGS. 2A and 2B, one of the aircraft wings 12 is illustrated in more detail, with the slat 16 being shown positioned in the retracted position in FIG. 2A and being shown in the extended position in FIG. 2B. The fixed wing 14 comprises a structural wall 20 (e.g., a spar) and a Wall 22 extending therefrom to form its leading edge. A torque tube 24 located within the fixed wing 14 forms part of the drive mechanism for moving the slat 16 between the retracted position and the extended position. The slat 16 comprises a structural wall 30 (e.g., its coveskin) and a wall 32 extending therefrom to form its leading edge.

The slat 16 also includes an electrically operated ice protection system 34 (e.g., an electrothermal system). Electrical power lines 36 and electrical sensor lines 38 are used to power and/or control this system 34. These electrical lines 36/38 are connected to an on-board power source and/or controller whereby they extend between the fixed wing 14 and the slat 16.

The electrical lines 36/38 can comprise or form part of cables (i.e., an assembly of wires and fillers enclosed in a shield and jacket), wire bundles (i.e., cables with connectors and connector assemblies added), and/or bundle assemblies (i.e., wire bundles, mechanical supports and enclosures required for guiding and supporting the wire bundles). In the illustrated embodiment, the electrical lines 36 and the electrical lines 38 each comprise a wire bundle having a plurality of cables connected in series. Specifically, as is best seen by referring briefly to FIGS. 4-6, the electrical lines 36 and 38 include electrical lines 36_{fixed} and 38_{fixed} extending from the fixed wing 14 to the on-board power source and controller, electrical lines 36ₗᵢₙₖ and 38ₗᵢₙₖ extending through the linkage 40, and electrical lines 36ₛₗₐₜ and 38ₛₗₐₜ extending through the slat 16 to the ice protection system 34.

According to the present invention, a linkage 40 is provided to house the electrical lines 36/38. The linkage 40 is convertible between a retracted condition when the slat 16 is in the retracted position (FIG. 2A) and an extended condition when the slat 16 is in the extended position (FIG. 2B). The linkage 40 accommodates the repeated extension and retraction of the slat 16 and protects the electrical lines 36/38 from the adverse slat environment. This environment can include, for example, hot/cold temperatures, high altitudes, and humidity extremes, excessive vibration, and accelerated wind speeds, as well as exposure to fluids, salt spray, sand and dust.

If the aircraft 10 includes multiple leading edge slats 16 for each fixed wing 14, a separate linkage 40 (and separate electrical lines 36 and 38) for each slat 16 can be used. The use of separate linkages minimizes the possibility of harness failure in the event that the slats 16 fail to move together and/or it facilitates individual slat removal and replacement.

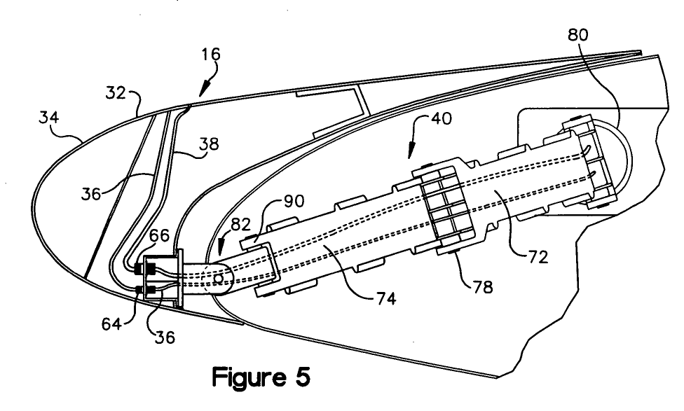

Referring now to FIGS. 4 and 5, the fixed wing 14 includes a linkage interface bracket 50 and an electrical interface bracket 52. As is explained in more detail below, the linkage 40 is connected to the mechanical interface bracket 50 and the electrical lines 36ₗᵢₙₖ and 38ₗᵢₙₖ extend therethrough into the linkage 40. The electrical interface bracket 52 carries an electrical connector 54 and an electrical connector 56 which form a connection between the electrical lines 36ₗᵢₙₖ and 36_{fixed} and the electrical lines 38ₗᵢₙₖ and 38_{fixed}, respectively. (As was explained above, electrical lines 36_{fixed} and 38_{fixed} are connected to the on-board power source and/or controller.) A plate 58 extending between the brackets 50 and 52 can be positioned to separate the electrical lines 36ₗᵢₙₖ and 38ₗᵢₙₖ as they extend from the linkage 40 to the connectors 54 and 56.

As is best seen by referring to FIG. 5, the slat 16 includes a box 60 forming a pocket in an opening in its structural wall 30 and a cover 62 for the box's open rear side. The electrical lines 36ₗᵢₙₖ and 38ₗᵢₙₖ pass through an opening in the cover 62 and through the box 60 to connectors 64 and 66. The connectors 64 and 66 are mounted in the front side of the box 60 and form electrical connections between the lines 36ₗᵢₙₖ and 36ₛₗₐₜ and the lines 38ₗᵢₙₖ and 38ₛₗₐₜ, respectively. A plate 68 can be positioned within the box 60 to separate the electrical lines 36ₗᵢₙₖ and 38ₗᵢₙₖ as they pass therethrough to the connectors 64 and 66. As is explained in more detail below, the linkage 40 is pivotally connected to the cover 62.

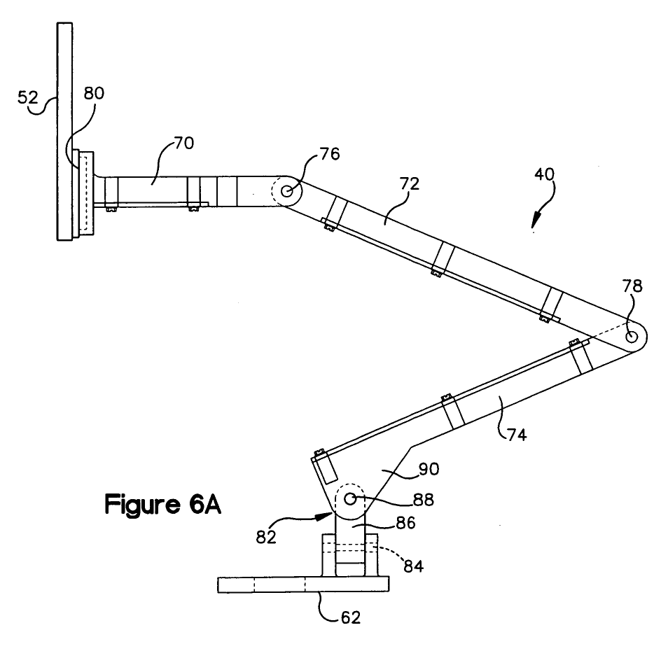

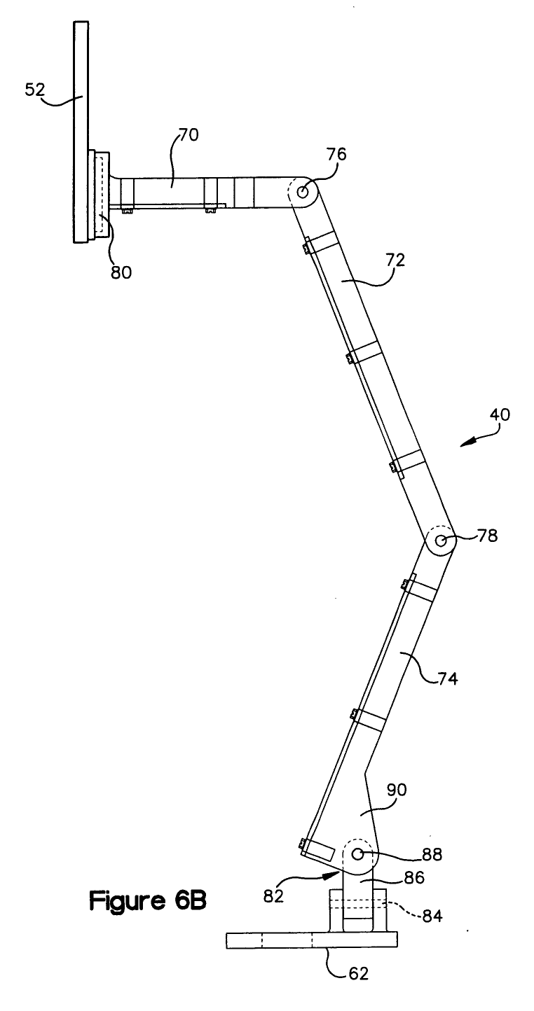

Referring now to FIGS. 6A and 6B, the linkage 40 is shown in a retracted condition and an extended condition, respectively. The linkage 40 comprises a plurality of links 70, 72, and 74 which, in the illustrated embodiment, have generally straight profiles although curved or angled links can be used if necessary and/or appropriate. The links are connected together by pivot joints 76 and 78, with the joint 76 connecting one end of the intermediate link 72 to the link 70 and the joint 78 connecting the other end of the intermediate link 72 to the link 74.

In the illustrated embodiment, the link 70 is oriented span-wise and runs parallel to and forward of the wall 30 of the fixed wing 14. The link 70 is rotatably connected to the fixed wing 14 and, more particularly, to the bracket 52, via a rotational joint 80 (e.g., the link 70 is mounted to the race of a ball bearing) which allows the link 70 to rotate about its axis. As is best seen by referring briefly back to FIG. 4, the link 70 is positioned approximately parallel to, and in any event away from, the torque tube 24 and a clearance zone therearound. Such a clearance assures that the linkage 40 does not interfere with the primary drive mechanism which moves the slat 16 between its retracted and extended positions.

The link 74 is connected to the slat 16 via a gimbal joint 82 (e.g., a two-axis hinge). The illustrated joint 82 includes a first pivot pin 84 between the cover 62 and a rod 86, and a second pivot pin 88 between the rod 86 and a flanged ear 90 on the end of the link 74. The pin 84 and/or the pin 88 can be a shear pin having a breakaway force (e.g., 200 lbf to 500 lbf) sufficient to allow the linkage 40 to sever itself from the slat 16 in the event of slat failure. The connectors 64 and 66 (see FIG. 5) can likewise be designed to allow a quick separation in the event of slat failure. In this manner, should the slat 16 completely separate from the fixed wing 14 during flight, only a minimal amount of material (e.g., about five pounds or less) will remain attached to the fixed wing 14.

The linkage 40 pivots in three dimensions as it extends and retracts during movement of the slat 16 relative to the fixed wing 14. The actual path of the linkage 40 is based on slat geometry and slat trajectory, and will vary from aircraft to aircraft. In the illustrated embodiment, the range of travel will be about fifteen inches through an arc of about twenty-nine degrees, with the entire linkage 40 pivoting about seventeen inches about the span-wise axis of the link 70. The linkage 40 can also be designed, as the illustrated linkage is, to accommodate vertical stepping of the slat 16 during dis-engagement and re-engagement with the fixed wing 14.

The linkage 40 can be totally self-supporting through the necessary range of motion so as to not put any significant strain on the fixed wing 14 and/or the slat 16. Additionally, the joints 76, 78, 80 and 82 can be selected to provide very low frictional resistance to the slat drive mechanism so that no additional force is necessary to move the slat 16 between its retracted and extended positions. For example, the joints 76, 78, 80, and 82 can each include sealed bearings which will also help to ensure long life and minimal wear of the joints and thus the linkage 40.

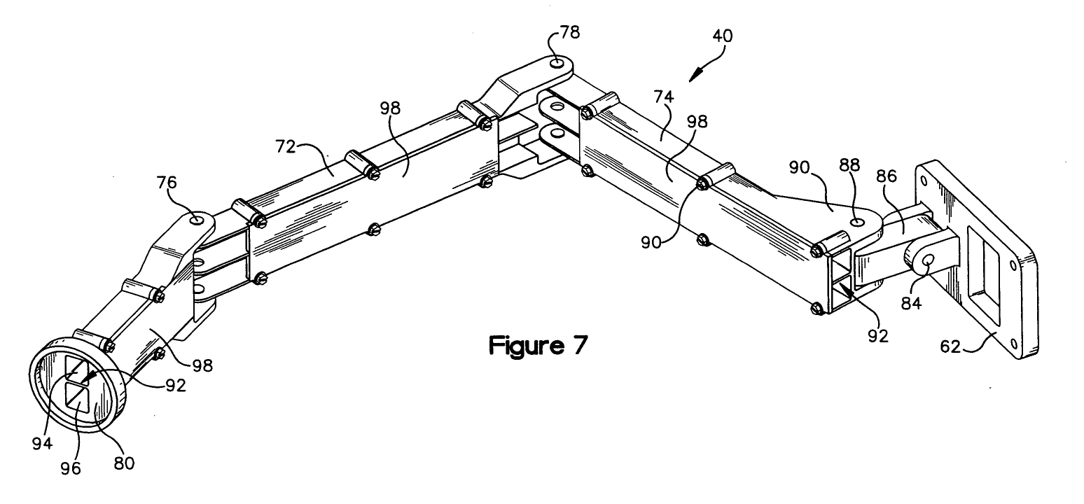

Referring now to FIG. 7, further details of the linkage 40 are illustrated, particularly those details related to the housing of the electrical lines 36 and 38. As shown, the links 70, 72 and 74 each define a chamber 92 and, in the illustrated embodiment, each chamber 92 has two channels 94 and 96. In this manner, the power lines 36 can be positioned within the channels 94 and the sensor lines 38 can be positioned within the channels 96. That being said, the electrical lines 36/38 can instead be part of a bundle assembly which itself provides physical separation of the power lines 36 and the sensor lines 38, whereby the channels 94 and 96 (and the separator plates 58 and 68 discussed above) may not be necessary. Moreover, there may be cases where physical separation of electrical lines is not crucial and/or not necessary.

The joints 76, 78, 80 and 82 are designed to accommodate the passage of the electrical lines 36/38, regardless of whether the chambers 92 are channeled. For example, the pivot pins 76, 78, 84 and 88 can be formed by two sections to thereby allow unobstructed travel of the electrical lines 36/38 therethrough. The rotational joint 80 can have a central opening through which the electrical lines 36/38 can pass into the chamber 92 of the link 70.

During movement of the linkage 40 between its retracted condition and its extended condition, the electrical lines 36/38 will bend as the links 70, 72 and 74 pivot relative to each other. Accordingly, they must possess a sufficient amount of flexibility to tolerate this limited degree of bending (which is much less than the bending required, for example, with an extendable telephone-cord coiled arrangement). However, the electrical lines 36/38 do not move axially within the linkage 40 as might be the case with, for example, a telescoping arrangement. The limited bending required by the electric lines 36/38 and/or the fact that they do not move axially within the linkage 40, minimizes the potential for electrical line abrasion (and associated consequences) during the life of the aircraft 10.

Removable covers 98 can be provided for each of the links 70/72/74 to protect the electrical lines 36/38 positioned therewithin. The covers 98 are preferably designed for easy removal (e.g., they have quick-connect features) to allow periodic inspection of the electrical lines 36/38 with disassembly of the linkage 40. Drain holes (not shown and/or numbered) may be provided in each link 70/72/74 to remove any collected moisture within the chambers 92. Although not specifically shown in the drawing, bellows or other flexible covers can be provided for the joints 76, 78 and 82 to protect the adjacent sections of the electrical lines 36/38 and to seal the linkage chambers 92.

One may now appreciate that the present invention provides a linkage 40 which allows an electrical ice protection system (or any other electrical system) to be used on a leading edge slat. The linkage 40 may also be used to house pneumatic or hydraulic lines that need to extend between a fixed wing and a slat. Moreover, the linkage 40 can be used in other aircraft and non-aircraft applications which require electrical, pneumatic, hydraulic or other lines to extend between two relatively movable structures. Although the invention has been shown and described with respect to a certain preferred embodiment, it is evident that equivalent and obvious alterations and modifications will occur to others skilled in the art upon the reading and understanding of this specification. The present invention includes all such alterations and modifications and is limited only by the scope of the following claims.

1. An aircraft wing comprising:
a fixed wing;
a slat movable relative to the fixed wing between a retracted position and an extended position;
electrical lines extending between the fixed wing and an electrical system on the slat; and
a linkage housing the electrical lines and convertible between a retracted condition when the slat is in the retracted position and an extended condition when the slat is in the extended position.

2. An aircraft wing as set forth in claim 1, wherein the electrical system is an electric ice protection system.

3. An aircraft wing as set forth in claim 1, wherein the linkage comprises a joint designed to break at a force sufficient to insure that the linkage will breakaway from the slat and/or the fixed wing should the slat be separated from the fixed wing during flight.

4. An aircraft wing as set forth in claim 1, wherein the linkage comprises chambers each having a plurality of channels, and wherein one set of the electrical lines extend through one set of channels and another set of the electrical lines extend through another set of channels.

5. An aircraft wing as set forth in claim 4, wherein the one set of electrical lines are electrical power lines and the other set of electrical lines are electrical sensor lines.

6. An aircraft wing as set forth in claim 1, wherein the linkage comprises a plurality of links and joints connecting the plurality of links to the fixed wing, the slat, and each other, and wherein the joints accommodate the passage of the electrical lines therethrough.

7. An aircraft wing as set forth in claim 6, wherein the plurality of links include a first link connected to the fixed wing, a second link connected to the slat, and an intermediate link therebetween.

8. An aircraft wing as set forth in claim 7, wherein the one end of the intermediate link is connected to the first link by a pivot joint and the other end of the intermediate link is connected to the second link by a pivot joint, and wherein the electrical lines pass through each pivot joint.

9. An aircraft wing as set forth in claim 7, wherein the first link is connected to the fixed wing by a rotational joint whereby the first link is rotatable about its axis.

10. An aircraft wing as set forth in claim 9, wherein the rotational joint has a central opening and the electrical lines pass therethrough.

11. An aircraft wing as set forth in claim 9, wherein the second link is connected to the slat by a gimbal joint whereby the second link is pivotal relative to the slat about two axes.

12. An aircraft wing as set forth in claim 7, wherein the second link is connected to the slat by a gimbal joint whereby the second link is pivotal relative to the slat about two axes.

13. An aircraft wing as set forth in claim 10, wherein the gimbal joint includes a first pivot pin and a second pivot pin, and wherein at least one of these pivot pins is designed to break at a force sufficient to insure that the linkage will breakaway from the slat and/or the fixed wing should the slat be separated from the fixed wing during flight.

14. An aircraft wing as set forth in claim 1, wherein the electrical lines extending through the linkage are connected to electrical lines in the fixed wing via one or more electrical connectors and/or wherein the electrical lines extending through the linkage are connected to electrical lines in the slat via one or more electrical connectors.

15. An aircraft wing as set forth in claim 14, wherein the electrical lines in the fixed wing are connected to an onboard power source and/or controller.

16. An aircraft comprising a pair of wings as set forth in claim 1.

17. A linkage for housing lines that extend between a first structure and a second structure that are movable relative to each other; said linkage comprising:
a plurality of links; and
joints joining the links to the structures and to each other, and allowing pivoting in three dimensions as the first structure and the second structure move relative to each other.

18. A linkage as set forth in claim 17, wherein the lines extending between the first structure and the second structure are electrical, pneumatic or hydraulic lines.

19. In combination, a fixed wing, a slat movable relative to the fixed wing between a retracted position and an extended position, lines extending between the fixed wing and a system on the slat, and the linkage set forth in claim 17; wherein the first structure is the fixed wing and the second structure is the leading edge slat; and wherein the linkage houses the lines extending between the fixed wing and the system on the slat.

20. The combination set forth in claim 19, wherein the lines extending between the fixed wing and the system on the slat are electric, hydraulic, or pneumatic lines.
